(19) United States
(12) Patent Application Publication
(10) Pub. No.: US 2010/0166227 A1
(43) Pub. Date: Jul. 1, 2010

(54) CIRCUITS FOR BIASING/CHARGING HIGH IMPEDANCE LOADS

(76) Inventor: John Laurence Pennock, Midlothian (GB)

Correspondence Address: DICKSTEIN SHAPIRO LLP, 1825 EYE STREET NW, Washington, DC, 20006-5403, US

(21) Appl. No.: 12/649,965

(22) Filed: Dec. 30, 2009

(30) Foreign Application Priority Data
Dec. 30, 2008 (GB) 0823652.3

(51) Int. Cl. H04R 3/00; H02J 7/00

(52) U.S. Cl. 381/111; 320/166

(57) ABSTRACT

A charging circuit for charging/biasing high impedance loads such as capacitive loads. The circuit comprises an input for connecting to a voltage/charge source and an output for connecting to the load. A capacitor is connected between the output and a reference voltage such as ground and a reverse bias diode is connected between the input and the output terminals. The reverse bias diode is arranged to allow a reverse current to pass which is sufficient to compensate for current leakage at the output terminal or other parts of the circuit. The reverse bias diode is conveniently a polysilicon diode. The diode may be connected in parallel with a shunt device to allow for rapid charging during start up.

### BACKGROUND OF THE INVENTION

1. Field of the Invention

The present invention relates to a circuit arrangement for use in biasing or charging circuits, especially for biasing or charging of capacitive loads and in particular MEMS transducers.

2. Description of the Related Art

Consumer electronics devices are continually getting smaller and, with advances in technology, are gaining ever increasing performance and functionality. This is clearly evident in the technology used in consumer electronic products such as mobile phones, laptop computers, MP3 players and personal digital assistants (PDAs). Requirements of the mobile phone industry for example, are driving the components to become smaller with higher functionality and reduced cost. For example, some mobile phones now require multiple microphones for noise cancelling, or accelerometers to allow inertial navigation, while maintaining or reducing the small form factor and aiming at a similar total cost to previous generation phones.

This has encouraged the emergence of miniature transducers, initially electret microphones, more recently micro-electrical-mechanical systems (MEMS) based devices. These may be, for example, pressure sensors, ultrasonic transducers, accelerometers, and microphones. Many of these devices are capacitive transducers, comprising one or more membranes with electrodes for read-out/drive deposited on the membranes and/or a substrate. Relative movement of these electrodes modulates the capacitance between them, which then has to be detected by sensitive electronic amplifiers.

For microphones, for example, the wide dynamic range of audio signals, from deafening overload to almost inaudible, results in an output voltage level of a few millivolts for normal sound levels and a requirement for equivalent total input noise level within the audio band of only a few microvolts. Even these voltage levels require a high voltage (say 12V) bias voltage to be imposed across the microphone transducer, typically generated from a lower supply voltage by a charge pump and a low-voltage voltage reference voltage (say 1.2V). Such an amplified bias voltage generator will be inherently noisy, yet any audio band noise on its output will cause a signal at the other end of the transducer that is indistinguishable from a similar audio noise stimulus.

A reservoir capacitor may be placed on the output of the voltage generator, coupled via a diode to the voltage generator. After start-up, the voltage generator merely needs to supply enough current to compensate for the leakage current to ground from the bias node, typically up to the order of a picoamp, but possibly tens of picoamps in humid conditions or at high temperature. However, even these low currents may cause the diode to conduct strongly enough to couple audio band noise onto the bias node. The small size of the microphone package, and stringent cost constraints preclude a reservoir capacitor of more than a few tens of picofarads since a larger on-chip capacitor would take up excessive chip area and a discrete capacitor would not fit in the small package, so a passive filter is not practical due to the excessive resistor size (of the order of gigaohms) that would be required.

To discuss the problem in more detail, FIG. 1 illustrates a schematic diagram of a MEMS device 99 comprising a MEMS transducer 100 and an electronic circuit 102.

The MEMS transducer 100 is shown as being formed on a separate integrated circuit to the electronic circuit 102, the two being electrically connected using, for example, bond wires 112, 124. The MEMS transducer 100 comprises a MEMS capacitor C_{MEMS} having first 118 and second 120 plates that are respectively connected to first 114 and second 122 bond pads.

The electronic circuit 102 comprises a charge pump 104, a diode 106 and a reservoir capacitor 108, an amplifier 128, a bias resistance 135, third 110 fourth 126 and fifth 130 bond pads and an optional analogue-to-digital converter (ADC) 132 with associated sixth bond pad 134.

The following now describes the basic operation of the MEMS device.

The charge pump 104 receives a supply voltage VDD and a first reference voltage V_{REF1} and outputs an output voltage (that is greater than the supply voltage VDD), via the diode 106 and first 114 and third 110 bond pads (and associated bond wire 112), to bias the first 118 plate of the MEMS capacitor C_{MEMS}.

Since the voltage on pad 114 is rendered substantially constant by the reservoir capacitor 108, and the impedance presented by the other elements attached to pad 122 and 126 is higher than that of C_{MEMS} in the signal band, the voltage signal generated across the MEMS capacitor C_{MEMS} in response to a sound pressure wave appears on bond pad 122.

The amplifier 128 receives, via the second 124 and fourth 126 bond pads (and associated bond wire 124), the analogue voltage signal from the MEMS capacitor C_{MEMS} and amplifies it. The amplified analogue signal, which may be a current or a voltage depending upon the type of amplifier 128 used, is then output, for further processing, via the fifth bond pad 130. Alternatively, the electronic circuitry 102 may comprise an ADC, in which case, the amplified analogue signal is output, via the sixth bond pad 134, as a digital signal. The digital signal may be output instead of, or in addition to, the amplified analogue signal. The amplifier also receives a second bias voltage V_{REF2} via a high value bias impedance Rbias 135. The second bias voltage V_{REF2} also biases the second plate 120 of the MEMS capacitor C_{MEMS} , resulting in a bias voltage across C_{MEMS} of (Vb−V_{REF2}).

One problem associated with the arrangement of FIG. 1 relates to the possible leakage current from the bias node 110, 114 shown diagrammatically as a current source 125 to ground, though this leakage could be leakage current to other nodes, for example between the bond pads 114 and 122, or a resistive path, or indeed some non-linear characteristic such as Fowler-Nordheimn tunnelling across the sensor, or leakage from an ESD diode on pad 110.

FIG. 2 illustrates an electrical small-signal equivalent circuit of the diode 106 and capacitor 108 when driving an output current Iₗₑₐₖ. A noise current source i_{nd}²=2.q.(2.Iₛ+Iₗₑₐₖ) is shown in parallel with the diode, which is represented as a small signal resistance r_{d}=(mkT/q)/(Iₛ+Iₗₑₐₖ), where Iₛ is the saturation current of the diode, and m is a non-ideality factor, approximately unity for a normal silicon diode. There will also be a current noise source Iₙₗ²from the bias node to ground due to the leakage source 125, for example a diode leakage will also have a shot noise of 2.q.Iₗₑₐₖ. There will also be a voltage noise vₙᵥ² from the upstream circuitry, for example a charge pump and the buffer or a bandgap reference from which the charge pump input voltage is controlled.

At an audio frequency, f, say 1 kHz, the impedance of the diode 106 will be much greater than that of the capacitor 108. The shot noise from the diode and leakage source will develop a voltage across this capacitor of sqrt((i_{nd}²+iₙₗ²)/2.pi.f.C).=sqrt(2.2.q.Iₗₑₐₖ/2.pi.f.C), This voltage noise is proportional to the square root of Iₗₑₐₖ so will increase 3 dB for each doubling of Ileak.

The noise coupled from upstream will pass through the diode conductance of approximately 1/r_{d}=(Iₗₑₐₖ)/(mkT/q) (assuming Iₗₑₐₖ>>Iₛ, where Iₛ is the saturation current of the diode) to feed a noise current of sqrt(v²). (Iₗₑₐₖ)/(mkT/q) onto the capacitor, developing a voltage noise component of sqrt(vₙᵥ²). (Iₗₑₐₖ)/(mkT/q)/(2.pi.f.C) on this capacitor. Note this voltage noise is directly proportional to Iₗₑₐₖ, so will increase 6 dB for each doubling of Iₗₑₐₖ.

Thus at small Iₗₑₐₖ, the noise will be dominated by the leakage shot noises, increasing at 3 dB per doubling of I_{leak,} but eventually there will be a knee, where the coupled noise will start to dominate and the noise will start to increase at 6 dB per doubling of Iₗₑₐₖ. FIG. 3 shows a typical characteristic of output noise density against Iₗₑₐₖ where 106 is a small npn diode on a 0.35 μm CMOS process (C=50 pf, sqrt(vₙᵥ²)=10 μV/rtHz, f=1 kHz)

Such a rapid rise in noise with leakage above such a knee is undesirable. It would be advantageous to couple the bias voltage generator to the bias voltage node without such a knee, or at least be able to delay the onset of such behaviour to higher leakage currents.

It is therefore an aim of the present invention to provide an arrangement which at least mitigates the noise contribution from biasing or charging circuitry.

### SUMMARY OF THE INVENTION

According to a first aspect of the present invention, there is provided a circuit for charging a high impedance load, the circuit comprising: an input terminal; an output terminal; a capacitor electrically connected between the output terminal and a reference voltage; a charging reverse bias diode electrically connected between the input terminal and the output terminal; and a shunt device connected across said reverse bias diode.

The circuit for charging according to the present invention therefore has an input terminal and an output terminal. As used herein the term terminal simply means an electrical connection. This may be a distinct connection to other circuitry, for instance a bond pad or connectors or the like. However where the charging circuit is integrated with other circuitry for instance the terminal may be formed by a conducting track or wire or the like.

In use the input terminal is connected to a charge/voltage source, possible via some amplifiers or other circuitry, and the output terminal is connected to the high impedance load, again possibly via some intermediate linking circuitry. The charging circuit has a capacitor arranged between the output terminal and a reference voltage which may, for example, by ground, or a stable positive or negative voltage. The circuit also has a reverse bias diode arranged between the input and output terminals, in other words a diode which is reverse biased in normal operation with regard to current flow from the input to the output terminal. The diode is a charging diode in the sense that it is arranged such that at least some of the current flow during charging the load (whether charging on initial power up or maintaining charge on the load) occurs through the diode. It will be appreciated therefore that the charging diode in the circuit is different from a diode which may be arranged in a charging circuit to protect some circuit component in the event of electrostatic discharge (ESD) or the like but which is not arranged to provide current flow for charging.

The reverse bias diode is therefore conveniently one that can allow a reverse current, under normal charged conditions, which is sufficient to compensate for current leakage at the output terminal. As the skilled person will understand there may be a variety of current leakage mechanisms associated with the high impedance load, the connections to the load and any circuitry between the charging circuit and the load, any or all of which could lead to current leakage at the output terminal. Thus the diode used in the charging circuit of the present invention is one which has a significant reverse, or leakage, current under normal charged conditions. This reverse current allows the diode to be reverse biased in the charging path and still allow the load to charge.

The reverse bias diode may be arranged to allow a reverse current of up to 100 pA, or it may be arranged to allow a reverse current of up to 10 pA or a reverse current of up to 1 pA.

The reverse current under normal operating conditions will depend on those conditions, for instance the expected voltage difference across the reverse bias diode. During normal operation, when the load is fully charged or at normal operating voltage, the voltage difference between the input and output terminals of the charging circuit, and hence the voltage across the reverse biased diode, may be relatively small. For instance the voltage difference may be of the order of less than 1V or less than 0.5V or less. The voltage difference may be of the order of 100 mV or so. Under such normal operating conditions the only charge loss may be due to current leakage. And the reverse current through the reverse bias diode may be in the range of hundreds of femotamps to picoamps or nanoamps. For instance the reverse current may be 100 fA or more and may be 1 nanoamp or less, or 100 pA or less, or 10 pA or less.

The reverse bias diode may have a saturation current in the range of 10 fA to 100 pA, or in the range 0.2-5 pA.

Conveniently the reverse bias diode comprises a polysilicon diode. Polysilicon diodes can be made which have the desired reverse current characteristics and also present a high impedance in reverse bias and hence are particularly suited for use as the reverse bias diode of the present invention. However other diodes may be suitable and could be used. Especially when the diode is formed from polysilicon, referred to herein as a poly diode, the diode may be a p-i-n diode. As described in more detail below the presence of a substantially intrinsic region between the p and n type regions mitigates against grain boundary effects found in a polysilicon diode. The intrinsic region may be intrinsic semiconductor material or may be lightly doped n or type material.

The reverse bias diode may comprise a multiple junction composite diode. As will be described more fully later a multiple junction composite diode comprises a plurality of regions of alternating p type and n type material. Such a composite diode thus comprises a plurality of pn and np (or pin/nip) junctions. Each such junction can be thought of as effectively comprising a diode arranged in electrical series with the other junction diodes. By appropriate choice of the number of junctions the characteristics of the overall composite diode can be varied to match the desired characteristics.

It should be noted that it is possible to use a composite junction diode which is symmetric. For instance a composite diode with p and n type regions arranged alternately and having a p type region at each end (or an n type region at each end) will have an equal number of pn junctions as np junctions. The dc characteristics of such a device are symmetric and thus the device does not have distinct forward and reverse bias modes. As used herein the term reverse bias means that the diode is arranged so that the current flow under normal operating conditions is the same or less than the current flow that would be observed were the diode to be connected the other way around.

The required characteristics can also be achieved by using more than one reverse bias diode. For instance the charging circuit may comprise at least one additional reverse bias diode electrically connected between the input terminal and the output terminal. The additional reverse bias diodes may be connected electrically in series or in parallel, or two or more diodes in electrical series may be connected in parallel with at least one other diode.

As will be described in more detail later, whilst the reverse bias diode does allow a reverse charging current to pass which is sufficient to compensate for current leakage, charging purely through the reverse bias diode could take significant times during initial start up. The circuit therefore comprises a shunt device connected across the reverse bias diode.

The shunt device is configured to pass current when the voltage level on the output terminal is below a threshold level and to pass substantially no current when the voltage level on the output terminal is above a threshold level. In other words, at device start up, the voltage on the output terminal may be low. In this case the shunt device allows current to pass to allow rapid charging of the device. However once the voltage level reaches the threshold level the shunt device ceases to pass current leaving the reverse bias diode as the charging path. The reverse current through the reverse bias diode can then complete any necessary charging to bring the output terminal up to the final operating voltage/current level and can allow sufficient current to pass to compensate for any leakage current. The threshold voltage may be a fixed threshold, i.e. a certain defined voltage, or may be a relative threshold, i.e. a certain voltage difference. The threshold level may be substantially the operating voltage of the capacitive load. The threshold level may be, for instance, within about 1V of the operating voltage of the capacitive load.

To allow for more rapid charging than possible through the reverse bias diode alone, the shunt device is configured to pass a current which is larger than the reverse current of the reverse bias diode when the voltage level on the output terminal is lower than the threshold level.

The shunt device may comprise at least one transistor element connected in parallel with the reverse bias diode and the transistor element may be arranged as a forward diode connected transistor. There may be two or more transistor elements connected in series. The shunt device may comprise a forward biased diode in parallel with the reverse bias diode. In this arrangement the charging circuit of the present invention comprises a forward biased diode in parallel with a reverse biased diode wherein the reverse bias diode has a reverse current, under normal operating conditions, sufficient to compensate for current leakage.

The threshold voltage level will thus be the voltage level at which the voltage difference across the transistor or forward biased diode of the shunt device at which the transistor or diode effectively switches off. For a conventional bipolar diode this voltage difference will be about 0.8V and hence the threshold voltage will be about 0.8V less than the operating voltage, i.e. the voltage level where the voltage difference between the input and output terminals is less than about 0.8V. The skilled person will appreciate that such a threshold is a relative threshold.

The charging circuit may also comprise a voltage bias device electrically connected to the input terminal, and the voltage bias device may comprise a charge pump.

The circuit may also comprise a capacitive transducer electrically connected to said output terminal. The transducer may be MEMS transducer, such as a microphone, having a first capacitive plate and a second capacitive plate and said first capacitive plate is electrically connected to said output terminal.

The circuit may also comprise at least one amplifier device electrically connected to said transducer arranged to amplify the electrical signals generated by said transducer.

An analogue to digital convertor device may also be arranged to convert electrical signals generated by said transducer into digital electrical signals.

The circuit may be formed as an integrated circuit.

A MEMS device incorporating a charging circuit of the present invention could be used in a range of applications, including, but not limited to, an ultrasound imager, a sonar transmitter and/or receiver, a mobile telephone, a personal desktop assistant, an MP3 player or other personal audio device or a laptop computer.

In another aspect of the invention there is provided a method of charging and/or biasing a high impedance load comprising the step of arranging a reverse bias diode between a voltage bias source and said capacitive load; arranging a capacitor between said high impedance load and a reference voltage such that at least some charging current passes through the reverse bias diode; and arranging a shunt device across the reverse bias diode, said shunt device being configured to pass current when the voltage level on the output terminal is below a threshold level and to pass substantially no current when the voltage level on the output terminal is above a threshold level. The high impedance load may be any load but may, in particular, be a capacitive load.

As described above in relation to the first aspect of the invention the method may involve allowing a reverse current to pass through said reverse bias diode, under normal charged conditions, which is sufficient to compensate for current leakage. The reverse bias diode may allow a reverse current of up to 100 pA, or up to 10 pA or up to 1 pA.

Conveniently the reverse bias diode comprises a polysilicon diode.

The method may involve the step of arranging a shunt device across the reverse bias diode, said shunt device being configured to pass current when the voltage level on the output terminal is below a threshold level and to pass substantially no current when the voltage level on the output terminal is above a threshold level. During a start up phase, i.e. when voltage/charge level of the capacitive load is significantly less than it would be under normal operating conditions, the method involves passing a charging current through the shunt device and, during an operative phase, i.e. normal charged operation, involves passing a charging current through the reverse bias diode sufficient to compensate for any current leakage, wherein the charging current that can be passed through the shunt device is greater than the charging current that can be passed through the reverse bias diode so as to allow for rapid charging during the start up phase.

The shunt device may comprise at least one transistor element and/or at least one transistor element arranged in parallel with the reverse bias diode.

In another aspect of the invention there is provided A charging circuit for charging a high impedance load, the circuit comprising: an input terminal connected to a voltage bias source; an output terminal connected to said high impedance load; a capacitor electrically connected between the output terminal and a reference voltage; and a charging reverse bias diode electrically connected between the input terminal and the output terminal.

### BRIEF DESCRIPTION OF THE DRAWINGS

For a better understanding of the present invention, and to show more clearly how it may be carried into effect, reference will now be made, by way of example, to the following drawings, in which:

FIG. 1 illustrates an electronic circuit for a transducer;

FIG. 2 illustrates the noise equivalent capacitor-diode circuit of FIG. 1;

FIG. 3 shows the output noise density against leakage current for the circuit illustrated in FIG. 2;

FIG. 4 illustrates a circuit arrangement according to an embodiment of the present invention;

FIG. 5a illustrates a poly diode which may be used in an embodiment of the present invention;

FIG. 5b shows a plan view of the poly diode of FIG. 5a;

FIG. 5c shows the current-voltage characteristics of the poly diode of FIG. 5a;

FIG. 5d illustrates a composite poly diode which may be used in the present invention;

FIG. 6 shows the comparison between output noise density against leakage current for the embodiment of the present invention shown in FIG. 4 and the circuit shown in FIG. 2,

FIG. 7a shows a circuit arrangement according to another embodiment of the invention;

FIG. 7b illustrates a circuit arrangement according to a further aspect of the invention;

FIG. 8 shows the current voltage characteristics of the individual components of the circuits shows in FIGS. 7a and 7b and the overall circuit characteristics;

FIG. 9 shows a different plot of the current voltage characteristic of the embodiments shown in FIGS. 7a and 7b; and

FIG. 10 shows the noise characteristics of the embodiments shown in FIGS. 7a and 7b.

### DETAILED DESCRIPTION OF THE PREFERRED EMBODIMENTS

The embodiments below will be described in relation to charging a capacitive transducer such as a MEMS microphone. However it is noted that the invention is suitable not only for charging or biasing any type of capacitive load but also with other applications where charging or biasing is required with low noise. The skilled person will appreciate that a capacitive load can be regarded as a high impedance load and the invention is suitable for biasing other high impedance loads.

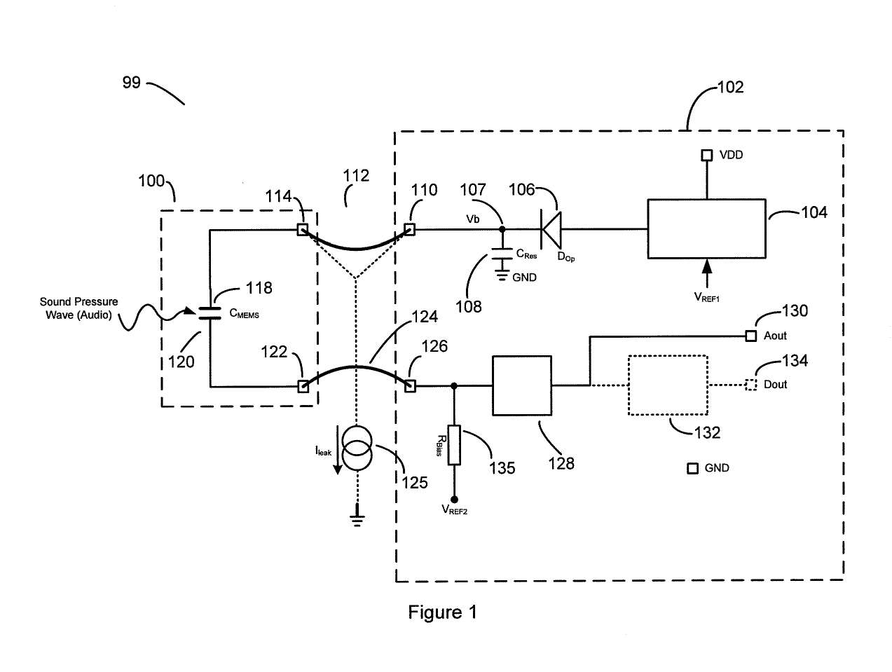

In an embodiment of the present invention, the forward biased diode 106 in FIG. 1 is replaced by a reverse biased diode DR 206 as shown in FIG. 4.

The reverse biased diode is preferably what may be referred to as a leaky diode i.e. it allows some current to flow from node X to node Y when reverse biased, i.e. it allows a small reverse current. Such leaky current flow is advantageous as it allows the voltage bias means to supply a current to compensate for any leakage current associated with the high impedance node Y, i.e. MEMS and/or reservoir capacitors. It will be noted, as shown in FIG. 4, that the load is charged through the diode 206 such that any charge lost from the load is compensated by current flow through the reverse bias diode 206. Thus the diode 206 is located in the charging path in normal operating conditions.

The use of a diode which is reversed biased with respect to the charge pump or voltage bias source is clearly contrary to the conventional arrangement which would use a forward biased diode. The present inventors have realised however that a reverse biased diode can allow sufficient current flow to compensate for leakage current, especially if the diode is a leaky diode and that use of such a reverse biased diode has significant advantages in terms of noise performance as will be described below in more detail.

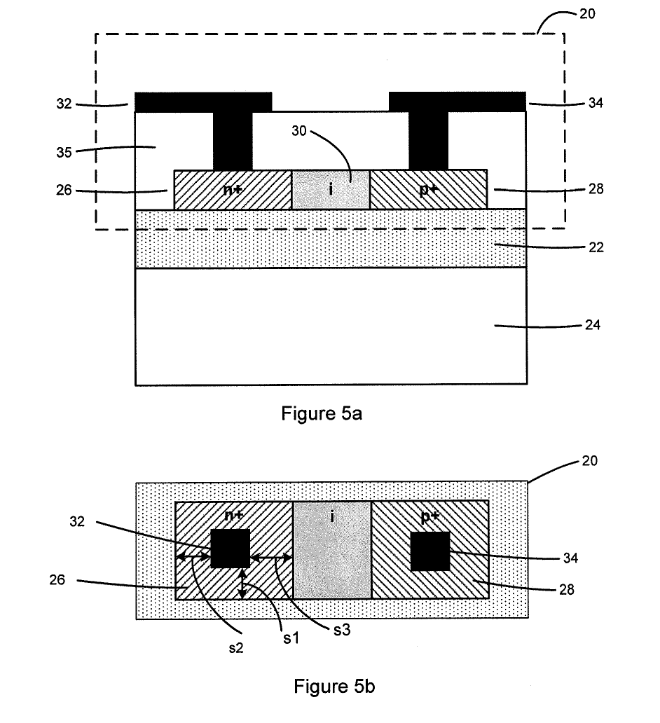

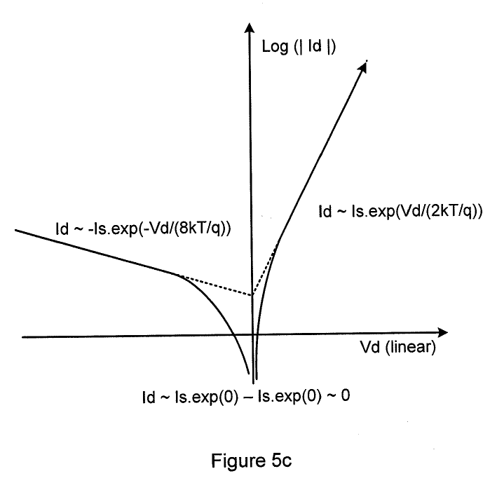

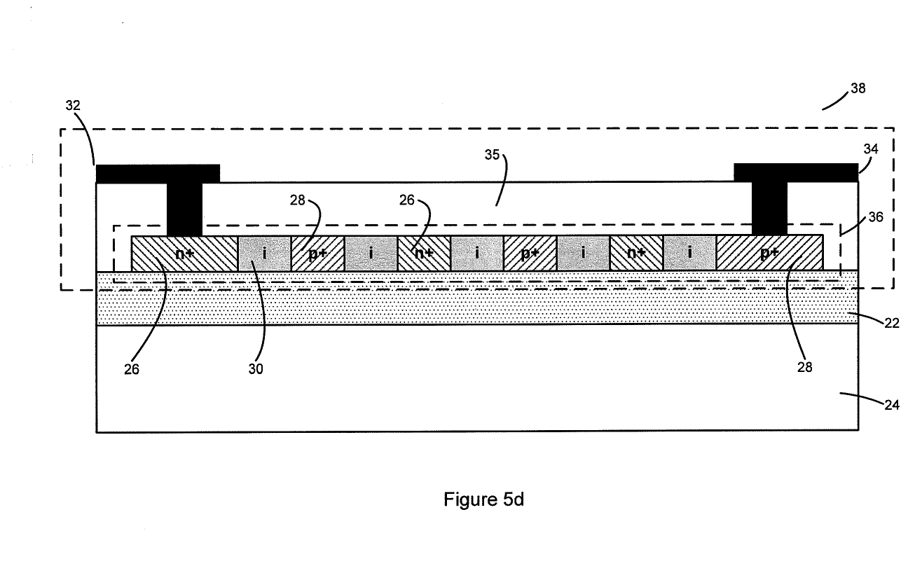

An example of a suitable diode with the desired leakage characteristics can take the form of a polysilicon diode element. FIG. 5a shows a known structure of such a polysilicon diode element 20 (referred to hereinafter as a “poly diode”).

The poly diode element 20 is disposed on a silicon dioxide layer 22, previously disposed on a silicon substrate 24. The poly diode element 20 itself comprises an n-type region 26 forming a p-n junction with a p-type region 28. If the n-type and p-type polysilicon regions are touching, low reverse breakdown voltages and/or high leakage of current are observed, as the n- and p-type regions 26, 28 are polycrystalline, creating effects at the grain boundaries. The low reverse breakdown voltages and/or high leakage of current can be adjusted by interposing an intervening drift region 30 of substantially intrinsic or lightly doped semiconductor material.

The n-type region 26 is electrically connected to an electrode 32, and the p-type region 28 is electrically connected to another electrode 34 through contact holes etched in an overlying insulating dielectric layer 35.

Typically this structure will be manufactured by first depositing a layer of intrinsic material, etching away superfluous material to leave a polysilicon region for the whole diode, than selectively implanting or diffusing n or p dopant on the respective portions of this intrinsic material. The insulating layer 35 is then deposited, and holes etched into it to accommodate the vertical elements of the metal electrodes 32, 34 which are then deposited to fill the holes and in patterns on the surface to connect with other circuit elements (not illustrated).

FIG. 5b shows a plan view of the poly diode element 20, showing the first and second electrodes 32, 34 contacting the poly diode.

FIG. 5c shows the current-voltage curves for a single poly diode (20) such as shown in FIG. 5a. In forward bias, the current asymptotes to Is.exp(Vd/(2.kT/q), so Vd=(2kT/q)In(|Id|). In reverse bias, the current asymptotes to Is.exp(Vd/(8.kT/q) so Vd=(8kT/q)In(|Id|). Therefore, such a diode has an asymmetric characteristic. Moreover, in reverse bias the conductance is Id/(8.kT/q), so for a given current Id it is eight times smaller than the bipolar forward biased bipolar diode referred to above.

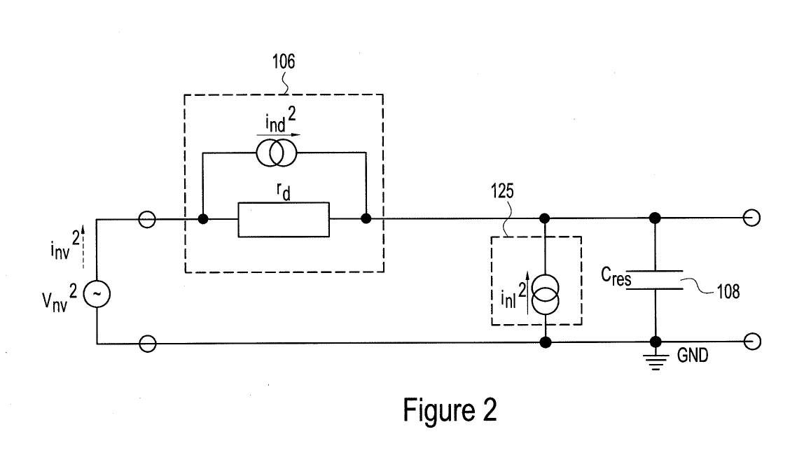

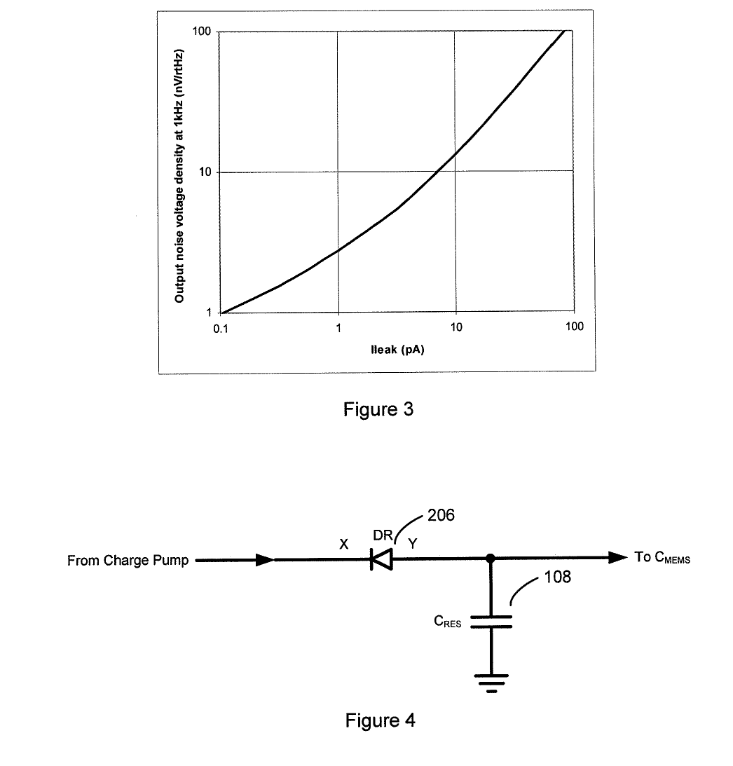

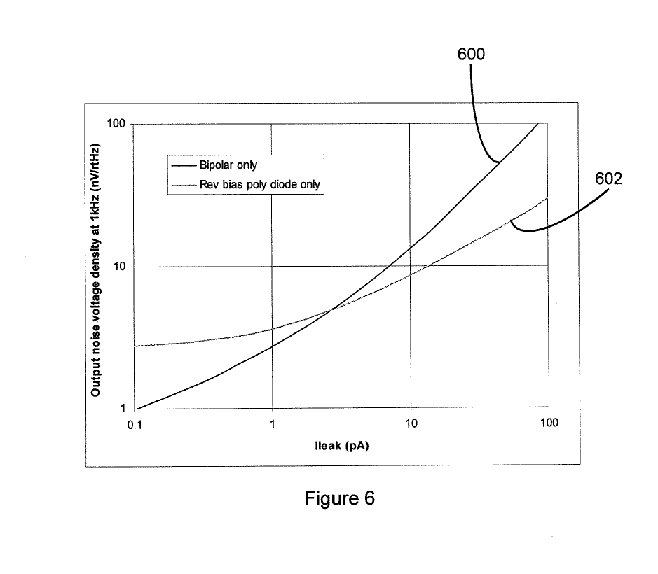

The corresponding electrical equivalent noise circuit is the same as FIG. 2a, except that the diode conductance 1/r_{d} is reduced by a factor eight for the same leakage current. Thus the noise current iₙᵥ² due to vₙᵥ² into the capacitor 108 is reduced by a factor of eight, and so the knee is moved up in current, reducing the additional noise voltage developed on the capacitor at the knee current and at higher currents. This is shown in the simulation of FIG. 6 which illustrates the noise density curve 602 for the reverse biased poly diode compared to the curve 600 for a forward biased npn diode.

Note the simulated current at low currents of the circuit incorporating a reverse biased leaky diode is slightly higher than that of the conventional circuit incorporating a forward biased bipolar diode. This is because even with zero net current a diode develops a shot noise current of 2.q.2.Is, where Iₛ is the diode saturation current, which may be of the order of a picoamp for a minimum size poly diode. However this noise is still low compared with the other noise sources in a system such as FIG. 1.

The reverse biased diode DR may comprise a single poly diode, or several poly diodes connected in series to give a lower effective conductance or in parallel to give a lower effective conductance from bias voltage generator to bias node and thus to modify the noise-current characteristic. When using a plurality of poly diodes to obtain a particular resistance value, the poly diodes may comprise a series of individual poly diodes connected in series. Alternatively a composite poly diode, having a continuous strip of polysilicon with a plurality of p-n and n-p (or nip and pin) junctions arranged to form a series of poly diode elements on a single substrate could be used. Such a composite diode structure is described in more detail in our co-pending application which has the reference P1200GB00 (P111707GB00). FIG. 5d shows a composite diode 38 which could be used where similar elements have the same numerals as used in FIG. 5a. A continuous strip of polysilicon 36 comprises a plurality of doped regions having alternating n-type regions 26 and p-type regions 28. As mentioned above, direct junctions between n- and p-type regions can cause leakage, and therefore in the illustrated embodiment the n- and p-type regions are preferably separated by regions 30 of substantially intrinsic semiconductor material (for example, polysilicon). It is noted, however, that the regions 30 may have some degree of light doping.

Although a poly diode such as shown in FIG. 5a or FIG. 5d or a series of such poly diodes are particularly suited for use in the present invention the invention is not limited to use of poly diodes. Any diode or diode arrangement which has sufficient reverse current, i.e. is sufficiently leaky, to allow satisfactory compensation for leakage current and also reduced conductance at a particular leakage current can be used in the present invention. The skilled person, having been taught the advantages of the present circuit arrangement, would be able to determine the leakage or reverse current for a particular diode or diode arrangement for a particular application and so would be able to identify suitable diodes. The diode may for instance have a saturation current of the order of 10 fA to 100 pA, or in the range of 0.2 pA to 5 pA. Under normal, fully charges, operating conditions there may be a very small driving voltage across the poly diode, for instance less than 1V or less than 0.5V. The voltage across the diode may be of the order of 100 mV or so. In such conditions the diode may pass a reverse current of up to 100 pA or less, or up to 10 pA or less or up to, or of the order of, 1 pA or less.

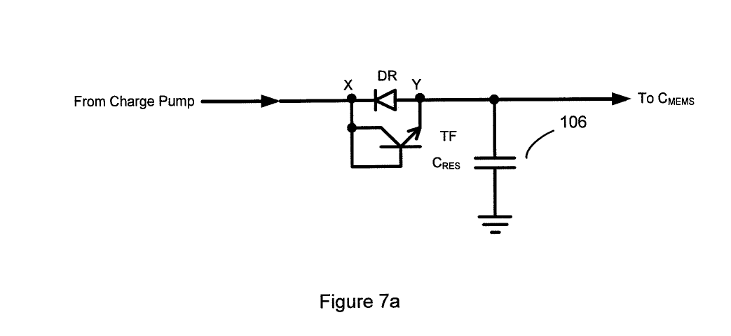

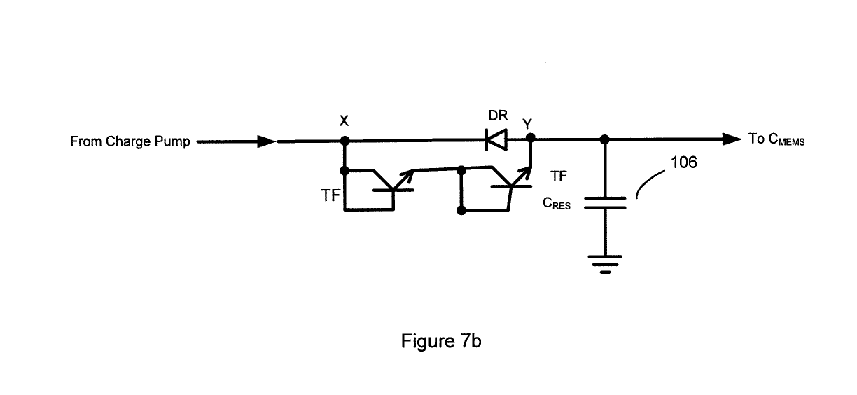

Since the reverse biased poly diode DR only allows a relatively small amount of current to flow from the charge pump, this means that the MEMS capacitive microphone C_{MEMS} will take a relatively long time to charge during start-up. To avoid this problem, a transistor TF can be connected across the poly diode DR to allow the capacitive transducer i.e. the MEMS capacitive microphone C_{MEMS}, to be charged more quickly during start-up. FIG. 7a shows a transistor TF connected across reverse biased diode DR as a forward diode connected transistor. FIG. 7b shows two such transistors connected in series connected across the reverse biased diode. Transistors TF are shown as forward diode connected transistors but the skilled person will appreciate that bipolar diodes, pn junction diodes or MOS transistors could be used.

At start up when the voltage at node X is much greater than the voltage at node Y the transistor TF is switched on, thereby allowing an increased amount of current to flow through the transistor T_{F} to enable the MEMS capacitive microphone C_{MEMS} to be charged more rapidly. As the voltage across the MEMS capacitive microphone C_{MEMS} becomes closer to the level of the input voltage the transistor T_{F} effectively switches off, leaving the reverse biased poly diode DR as the resistive element in the circuit.

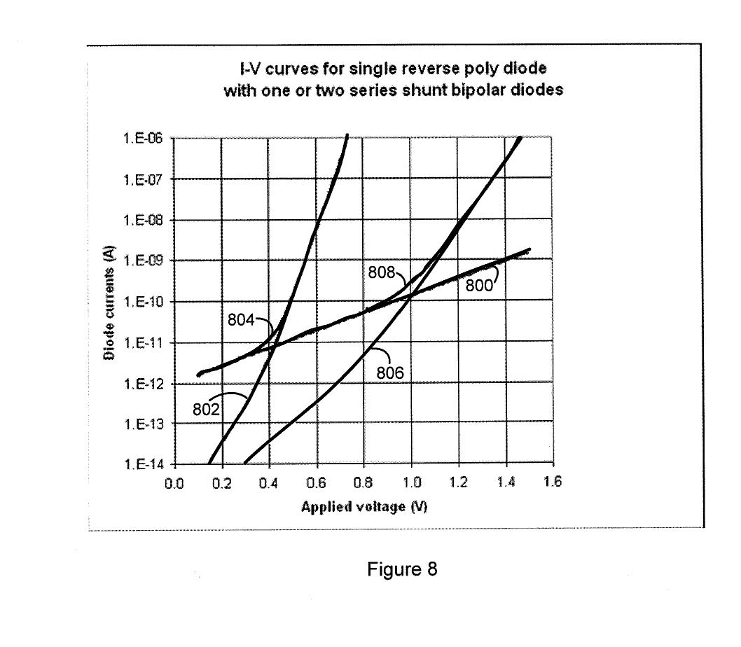

FIG. 8 shows the current-voltage characteristics of a reverse bias poly diode and also one bipolar transistor and two bipolar transistors in series. Curve 800 shows the current-voltage characteristics for a reverse bias poly diode such as shown in FIG. 5a. Curve 802 illustrates the current voltage characteristics for a forward biased diode connected bipolar transistor. It can be seen that at high voltages the bipolar transistor allows a relatively high current to flow as it is forward biased whereas the reverse biased poly diode allows a significantly lower current to flow. At lower applied voltages however, in this case less than about 0.4V, the reverse bias diode allows a greater reverse current to flow than the forward biased bipolar transistor. Curve 804 shows the current-voltage characteristic of a bipolar forward biased transistor in parallel with the reverse bias poly diode and it can be seen that at high voltage the current through the combined circuit matches that of the single bipolar transistor. In other words the majority of the charging current is flowing through the bipolar transistor. However at low applied voltages, as would be experienced as the load approaches the voltage level of the input, the resultant current characteristic 804 switches to match that of the reverse bias poly diode, i.e. the forward biased transistor effectively switches off and further charging continues through the reverse bias poly diode. For the single bipolar transistor in parallel with the poly diode this switch over occurs at around 0.4V applied voltage. It can be seen that the reverse current at this voltage is around 10 picoamps, which is sufficient to finish charging the load and maintain the charge against expected current leakage.

Curve 806 shows the current voltage characteristic for two bipolar diode connected transistors in series. This curve is similar to the curve for a single bipolar transistor but it can be seen that a greater applied voltage is required to give the same current. Curve 808 shows the overall characteristic for two serially connected bipolar transistors in parallel with a reverse bias poly diode. Again the bipolars provide the current path at high applied voltage but at low applied voltage the reverse bias poly diode takes over. In this case the transition occurs around 1.0V and 100 pA of current.

These curves shows that the addition of a diode connected transistor which is forward biased allows a higher charging current to be achieved at high applied voltage than would be possible with the reverse bias poly diode alone. A start up charging current of around 1 pA is plenty. A 50 pF capacitor will charge up through 11V in approximately 550 μs at a charging current of 1 μA. At low applied voltage however the reverse bias poly diode provides the charging current through a reverse current in the region of 100 pA-10 pA at 1.0V-0.6V down to about 1 pA at 0.1V.

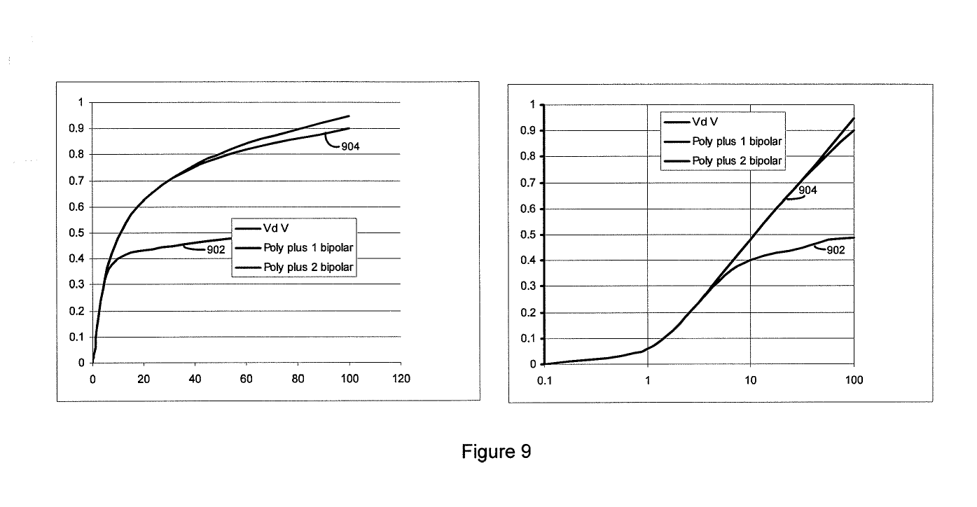

FIG. 9 shows a different plot of the current-voltage characteristics for arrangement shown in FIG. 7a having a single diode connected transistor connected across the reverse biased diode (curve 902)and also the arrangement shown in FIG. 7b having two transistors connected in series (curve 904). It can be seen that that at low voltages the current is effectively I_{spoly}.exp(Vd/(8.kT/q), i.e. the reverse bias current through the poly diode whereas at high voltages the current is related to the forward bias current through the bipolar transistor or transistors.

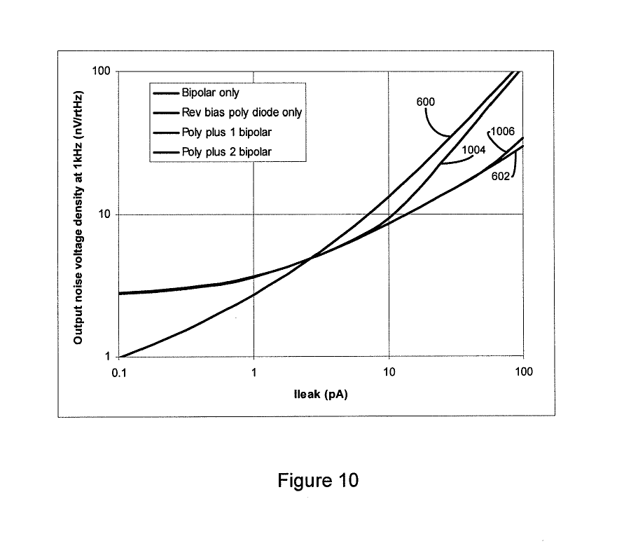

The incorporation of one or more diode connected transistors as described does however have an impact on noise. FIG. 10 shows the noise density characteristic for a single transistor (curve 1004), and also for two serially connected transistors (curve 1006), in parallel with a reverse biased poly diode compared to that of the poly diode on its own (curve 602) and a conventional bipolar forward biased diode arrangement (curve 600). It can be seen that the use of a single transistor increase the noise at higher leakage currents as compared to use of the reverse biased diode alone (although at a level which is still less than the conventional forward biased diode). Use of two diode connected transistors in series has a lesser effect on noise and allows for rapid charging.

This aspect of the invention has the advantage of using a poly diode for providing the required resistance, but without having a slow start-up time.

Although each transistor TF, which is arranged as a forward diode connected transistor, is illustrated as a bipolar type transistor it could alternatively be replaced by a MOS type transistor or a forward biased bipolar diode or pn junction diode.

The present invention can be used in the circuit shown in FIG. 1. The forward biased diode 106 shown in FIG. 1 being replaced by a reverse biased diode such as shown in FIG. 4 or a reverse bias diode in parallel with one or more transistors such as shown in FIG. 7a or 7b. It will be appreciated therefore that the present invention provides a means of applying a voltage bias and charging a capacitive load that has improved noise characteristics over the prior art. The circuit could be connected directly to the capacitive load or could be connected via bond pads such as shown in FIG. 1. The capacitive load may be a capacitive transducer such as a MEMS microphone such as shown in FIG. 1 or could be any capacitive load. Indeed the circuit arrangement according to the present invention can be used for any biasing or charging circuit or filter arrangement where noise associated with leakage current is to be minimised.

Thus the circuit could be used in a number of different devices including, but not limited to an ultrasound imager, a sonar transmitter and/or receiver, a mobile phone or other communication device, a personal desktop assistant, an MP3 player or other personal audio device or a laptop computer. The invention encompasses such an apparatus including a circuit as described.

It should be noted that the above-mentioned embodiments illustrate rather than limit the invention, and that those skilled in the art will be able to design many alternative embodiments without departing from the scope of the appended claims. The word “comprising” does not exclude the presence of elements or steps other than those listed in a claim, “a” or “an” does not exclude a plurality, and a single processor or other unit may fulfil the functions of several units recited in the claims. Any reference signs in the claims shall not be construed so as to limit their scope.

What is claimed is:

1. A circuit for charging a high impedance load, the circuit comprising:
an input terminal;
an output terminal;
a capacitor electrically connected between the output terminal and a reference voltage;
a charging reverse bias diode electrically connected between the input terminal and the output terminal; and
a shunt device connected across said reverse bias diode.

2. A circuit as claimed in claim 1 wherein said reverse bias diode can allow a reverse current, under normal charged conditions, which is sufficient to compensate for current leakage at the output terminal.

3. A circuit according to claim 1 wherein the diode can allow a reverse current of up to 100 pA, or up to 10 pA or up to 1 pA.

4. A circuit according to claim 1 wherein the diode has a saturation current in the range of 10 fA to 100 pA.

5. A circuit as claimed in claim 4 wherein the saturation current is in the range 0.2-5 pA.

6. A circuit as claimed in claim 1 wherein said reverse bias diode comprises a polysilicon diode.

7. A circuit as claimed in claim 1 wherein said reverse bias diode comprises a p-i-n diode.

8. A circuit as claimed in claim 1 wherein said reverse bias diode comprises a multiple junction composite diode.

9. A circuit as claimed in claim 1 further comprising at least one additional reverse bias diode electrically connected between the input terminal and the output terminal.

10. A circuit as claimed in claim 1 wherein said shunt device is configured to pass current when the voltage level on the output terminal is below a threshold level and to pass substantially no current when the voltage level on the output terminal is above a threshold level.

11. A circuit as claimed in claim 10 wherein the threshold level is substantially the operating voltage of the high impedance load.

12. A circuit as claimed in claim 11 wherein the threshold level is within about 1V of the operating voltage of the high impedance load.

13. A circuit as claimed in claim 10 wherein the shunt device is configured to pass a current which is larger than the reverse current of the reverse bias diode when the voltage level on the output terminal is lower than the threshold level.

14. A circuit as claimed in claim 1 wherein the shunt device comprises at least one transistor element connected in parallel with the reverse bias diode.

15. A circuit as claimed in claim 14 wherein said transistor element is arranged as a forward diode connected transistor.

16. A circuit as claimed in claim 14 wherein the shunt device comprises at least two serially connected transistor elements connected in parallel with the reverse bias diode.

17. A circuit as claimed in claim 1 wherein the shunt device comprises at least one forward biased diode connected in parallel with the reverse bias diode.

18. A circuit as claimed in claim 1 further comprising a voltage bias device electrically connected to the input terminal.

19. A circuit as claimed in claim 18 wherein the voltage bias device comprises a charge pump.

20. A circuit as claimed in claim 18 comprising a capacitive transducer electrically connected to said output terminal.

21. A circuit as claimed in claim 20 wherein the capacitive transducer comprises a MEMS transducer having a first capacitive plate and a second capacitive plate and said first capacitive plate is electrically connected to said output terminal.

22. A circuit as claimed in claim 21 wherein the MEMS transducer comprises a MEMS microphone.

23. A circuit as claimed in claims 20 further comprising at least one of: an amplifier device electrically connected to said transducer arranged to amplify the electrical signals generated by said transducer; and an analogue to digital convertor device configured to convert electrical signals generated by said transducer into digital electrical signals.

24. A device comprising the circuit of claim 1 wherein said device is at least one of: a MEMS device; an ultrasound imager; a sonar transmitter; a sonar receiver; a mobile phone; a personal desktop assistant; an MP3 player or other audio player; and a laptop.

25. A method of charging and/or biasing a high impedance load comprising the steps of: arranging a reverse bias diode between a voltage bias source and said capacitive load; arranging a capacitor between said high impedance load and a reference voltage such that at least some charging current passes through the reverse bias diode; and arranging a shunt device across the reverse bias diode, said shunt device being configured to pass current when the voltage level on the output terminal is below a threshold level and to pass substantially no current when the voltage level on the output terminal is above a threshold level.

26. A method as claimed in claim 25 comprising allowing a reverse current to pass through said reverse bias diode, under normal charged conditions, which is sufficient to compensate for current leakage.

27. A method as claimed in claim 26 wherein said reverse bias diode can allow a reverse current of up to 100 pA, or up to 10 pA or up to 1 pA.

28. A method as claimed in claim 25 wherein said reverse bias diode comprises a polysilicon diode.

29. A method as claimed in claim 25 wherein, during a start up phase, the method involves passing a charging current through the shunt device and, during an operative phase, involves passing a charging current through the reverse bias diode sufficient to compensate for any current leakage, wherein the charging current that can be passed through the shunt device is greater than the charging current that can be passed through the reverse bias diode.

30. A method as claimed in claim 25 wherein said shunt device comprises at least one transistor element.

31. A method as claimed in claim 25 wherein said shunt device comprises at least one forward biased diode connected in parallel with the reverse bias diode.

32. A charging circuit for charging a high impedance load, the circuit comprising:
an input terminal connected to a voltage bias source;
an output terminal connected to said high impedance load;
a capacitor electrically connected between the output terminal and a reference voltage; and
a charging reverse bias diode electrically connected between the input terminal and the output terminal.
